(19) United States
(12) Patent Application Publication
(10) Pub. No.: US 2010/0207564 A1
(43) Pub. Date: Aug. 19, 2010

(54) Power Source Estimation Methods and Apparatus

(75) Inventor: David Robinson, Mountain View, CA (US)

Correspondence Address: Pierce Atwood LLP, 160 Federal Street, 10th Floor, Boston, MA, 02110, US

(73) Assignee: Segway Inc.

(21) Appl. No.: 12/372,907

(22) Filed: Feb. 18, 2009

(51) Int. Cl. H02P 27/00

(52) U.S. Cl. 318/490

(57) ABSTRACT

A method for estimating power capability of a power source driving an electrical load can include obtaining initial values of power source parameters including a voltage value and a current value while preventing the power source from causing kinetic energy to be produced in the electrical load. The method can also include estimating power capability of the power source based on the initial values of the power source parameters.

### FIELD OF THE INVENTION

The invention generally relates to methods and apparatus for estimating power capability of a power source.

### BACKGROUND OF THE INVENTION

A wide range of power sources are known for powering electrical loads. Characterizing a power source's power delivery capabilities can be beneficial for knowing the expected lifetime or available output of the power source. In cases where the power source (e.g., a battery) provides power to an electrical load (e.g., electric motor) that creates propulsion for a transporter, understanding the power source's power delivery capabilities permits determination of, for example, the maximum operating speed of the transporter. Accordingly, improved methods and apparatus for estimating power capability of a power source are desired.

### SUMMARY OF THE INVENTION

The invention, in one aspect, features a method for estimating power capability of a power source (e.g., a battery) driving an electrical load. The method includes obtaining initial values of power source parameters including a voltage value and a current value while preventing the power source from causing kinetic energy to be produced in the electrical load. The method also includes estimating power capability of the power source based on the initial values of the power source parameters.

The electrical load can include two motors coupled to a common shaft. In some embodiments, the method for estimating power capability of a power source driving an electrical load includes commanding the two motors to produce equal but opposite torque to prevent the power source from causing kinetic energy to be produced in the electrical load.

In some embodiments, the electrical load includes at least one brushless motor and the method includes commanding a first component of current supplied to the motor to be substantially equal to zero and a second component of the current supplied to the motor to be non-zero. The first component can be out of phase with a magnetic field of a permanent magnet of the brushless motor and a second component can be in phase with the magnetic field of the permanent magnet of the brushless motor. The first component out of phase with the magnetic field can produce a mechanical torque and the second component in phase with the magnetic field would not produce a mechanical torque.

In some embodiments, the electrical load includes a first and second motor coupled to a common shaft and the method includes commanding the first motor to produce a torque and commanding the second motor with a position control loop to prevent rotation of the shaft. In some embodiments, the method includes commanding a component of current supplied to a first motor coupled to a shaft to be non-zero, where the component of the current supplied to the first motor is out of phase with a permanent magnet of the first motor. In some embodiments, the method includes commanding a second motor coupled to the shaft with a position control loop to prevent rotation of the shaft. In some embodiments, the electrical load varies as a function of time. In some embodiments, the method includes commanding a mechanical brake (e.g., a mechanical brake in the motor or in a transmission of a transporter) to prevent mechanical motion from being produced by a motor even if torque were to be applied by the motor. In some embodiments, the power source drives a motor and the method includes decoupling the motor from the power source to prevent kinetic energy from being produced by the power source in the electrical load.

The invention, in another aspect, features an apparatus for estimating power capability of a power source driving an electrical load. The apparatus includes a control module that prevents the power source from causing kinetic energy to be produced in the electrical load. The apparatus also includes a measurement module for measuring initial values of power source parameters including a voltage value and a current value and an estimation module adapted to estimate power source power capability based on the initial values of the power source parameters.

In some embodiments, the power source is a battery. The control module can be adapted to command two motors of the electrical load to produce equal but opposite torque to prevent the power source from causing kinetic energy to be produced in the electrical load.

In some embodiments, the control module is adapted to command a first component of current supplied to a motor of the electrical load to be substantially equal to zero and a second component of the current supplied to the motor to be non-zero. In some embodiments, the first component of the current is out of phase with a magnetic field of a permanent magnet of the motor and the second component of the current is in phase with the magnetic field of the permanent magnet of the motor. In this embodiment, the first component out of phase with the magnetic field can produce a mechanical torque and the second component in phase with the magnetic field does not produce a mechanical torque. In some embodiments, a mechanical brake (e.g., a mechanical brake in the motor or in a transmission of a transporter) prevents mechanical motion from being produced even if torque were to be applied by the motor.

In some embodiments, the control module is capable of (e.g., is adapted to) commanding a first motor of the electrical load to produce a torque and commanding a second motor of the electrical load, coupled to the first motor with a shaft, with a position control loop to prevent rotation of the shaft.

The control module can be capable of (e.g., is adapted to) commanding a component of current supplied to a first motor coupled to a shaft to be non-zero. In some embodiments, the component of the current is out of phase with a permanent magnet of the first motor. The control module can be capable of (e.g., is adapted to) commanding a second motor coupled to the shaft with a position control loop to prevent rotation of the shaft. In some embodiments, the measurement module measures power flowing out of the power source to obtain the initial values of power source parameters.

The invention, in yet another aspect, features an apparatus for estimating power capability of a power source driving an electrical load. The apparatus includes an input for receiving initial values of power source parameters including a voltage value and a current value that are obtained while preventing the power source from causing kinetic energy to be produced in the electrical load. The apparatus also includes an estimation module adapted to estimate power source power capability based on the initial values of the power source parameters.

The invention, in another aspect, features an apparatus for estimating power capability of a power source driving an electrical load. The apparatus includes a control module that prevents the power source from causing kinetic energy to be produced in the electrical load and a measurement means for measuring initial values of power source parameters including a voltage value and a current value. The apparatus also includes an estimation module adapted to estimate power source power capability based on the initial values of the power source parameters.

The invention, in another aspect, features a method for estimating power capability of a power source driving a transporter. The method includes obtaining initial values of power source parameters including a voltage value and a current value while preventing the power source from causing kinetic energy to be produced in the electrical load. The method also includes estimating power capability of the power source based on the initial values of the power source parameters prior to operation of the transporter by a user.

The invention, in another aspect, features a method for estimating power output capability of a power source driving an electrical load. The method includes obtaining initial values of power source parameters including a voltage value and a current value while preventing the power source from causing kinetic energy to be produced in the electrical load. The method also includes obtaining a value of a regeneration current received by the power source. The method also involves estimating a second voltage value of the power source based on the initial values of the power source parameters and the value of the regeneration current received by the power source. In some embodiments, the method involves estimating energy storage capability of the power source driving the electrical load based on the power output capability.

In some embodiments, the method includes monitoring the second voltage value of the power source and shunting power source current once the second voltage value has reached a threshold value.

Other aspects and advantages of the invention can become apparent from the following drawings and description, all of which illustrate the principles of the invention, by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a schematic illustration of a transporter, to which illustrative embodiments of the invention may advantageously be applied.

FIG. 2A is a circuit diagram of a power source, according to an illustrative embodiment of the invention.

FIG. 2B is a schematic illustration of an apparatus for estimating power capability of the power source of FIG. 2A, according to an illustrative embodiment of the invention.

FIG. 3 is a graphical representation of a model used to estimate an internal impedance of a power source, according to an illustrative embodiment of the invention.

FIG. 4A is a flow diagram illustrating a method for estimating parameters for a power source, according to an illustrative embodiment of the invention.

FIG. 4B is a flow diagram illustrating a method for determining initial values used to estimate parameters for a power source, according to an illustrative embodiment of the invention.

### DETAILED DESCRIPTION OF THE INVENTION

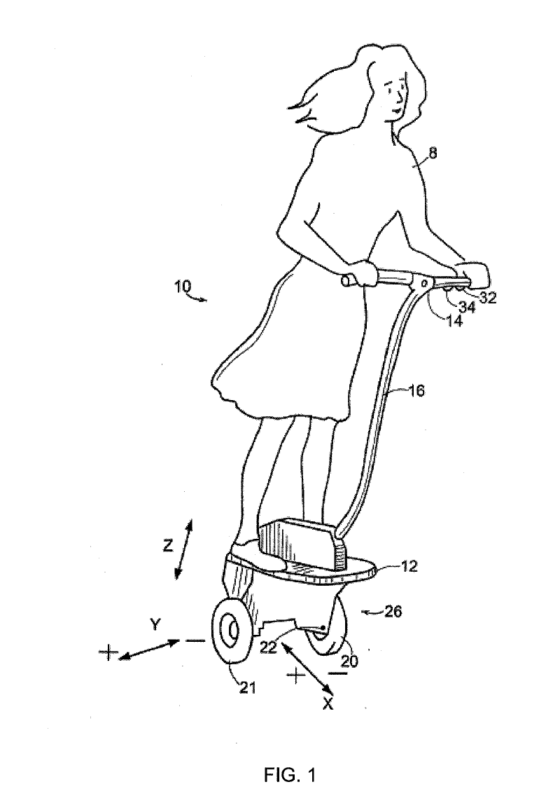

FIG. 1 is a schematic illustration of a transporter 10, as described in detail in U.S. Pat. No. 6,302,230 (the contents of which are hereby incorporated by reference), to which the illustrative embodiments of the invention may advantageously be applied. A subject 8 stands on a support platform 12 and holds a grip 14 on a handle 16 attached to the platform 12. The grip 14 includes controls 32 and 34 for operating the transporter 10. A control loop may be provided so that leaning of the subject results in the application of torque to wheel 20 about axle 22 by means of a motor drive.

The platform 12 is coupled to a base 26 that includes a motor and different numbers of wheels or other ground-contacting members 20 and 21 that can be used in various embodiments of the invention as particularly suited to varying applications. U.S. Patent Publication No. 2006/0108156, incorporated herein by reference, describes a balancing all-terrain vehicle. The all-terrain vehicle has two front wheels and two rear wheels. Each rear wheel is driven by its own actuator. Thus, within the scope of the present invention, the number of ground-contacting members 20 and 21 may be any number equal to, or greater than, one. Transporter 10 can be powered by a replaceable or rechargeable power source, such as a battery.

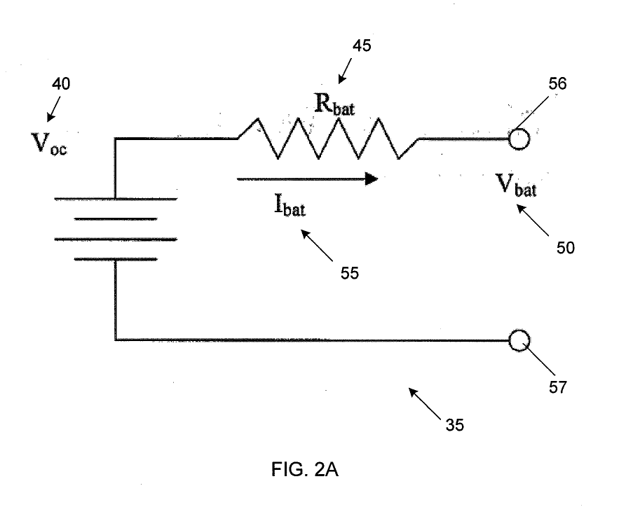

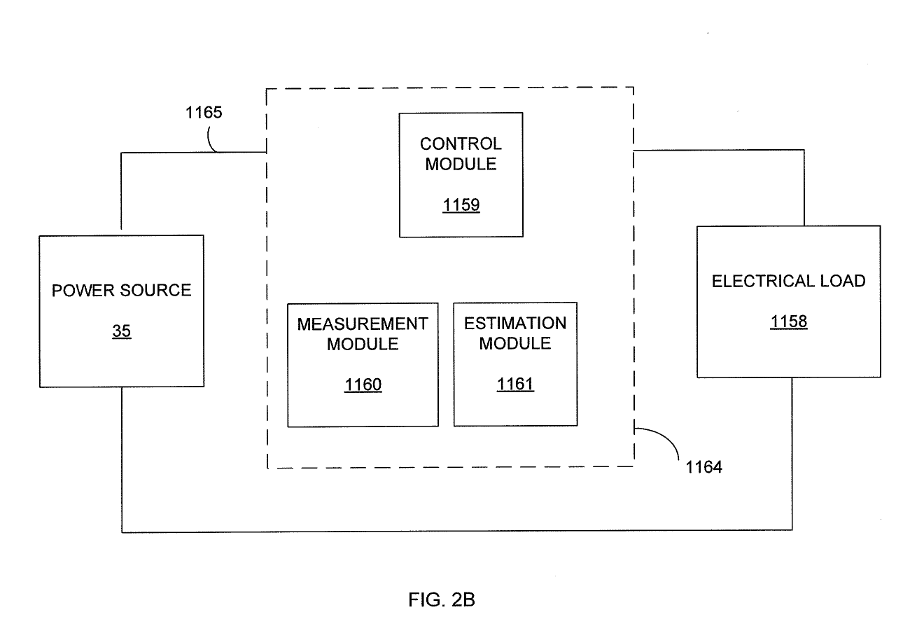

FIG. 2A is a circuit diagram of a power source 35, according to an illustrative embodiment of the invention. The power source 35 can drive an electrical load, such as an electrical motor used in a transporter as described above in FIG. 1. The power source 35 can be modeled as an open circuit voltage source (V_{oc} 40) with internal impedance (R_{bat} 45) and current flowing in the circuit (I_{bat} 55). The power source voltage (V_{bat} 50) can be measured at the terminals 56 and 57. For example, the power source 35 can be considered to consist of a “perfect” DC voltage source with “open circuit” voltage (V_{oc} 40), a series resistance for the power source (R_{bat} 45), a current (I_{bat} 55), and a power source voltage (V_{bat} 50). Model parameters V_{oc} 40 and R_{bat} 45 cannot be measured directly but can be estimated from measurements of V_{bat} 50 and I_{bat} 55.

V_{oc} 40 and R_{bat} 45 can vary during the discharge of a power source 35, therefore, V_{oc} 40 and R_{bat} 45 must be continuously estimated. A method for estimating the power available in a power source is described in U.S. Pat. No. 6,868,931, the contents of which have been incorporated by reference in its entirety. One method for estimating power capability of a power source driving an electrical load (e.g., a motor for a transporter 10) includes obtaining initial values of power source parameters including a voltage value (e.g., V_{bat} 50) and a current value (e.g., I_{bat} 55) while preventing the power source from causing kinetic energy to be produced in the electrical load. The method can also include estimating power capability of the power source based on the initial values of the power source parameters.

FIG. 2B is a schematic illustration of an apparatus for estimating power capability of the power source 35 of FIG. 2A, according to an illustrative embodiment of the invention. Power source 35 (e.g., a battery) drives an electric load 1158. Initialization of the power source 35 (e.g., estimation of the power capability of the power source) can be done without producing kinetic energy in the motor. An apparatus 1164 for estimating power capability of a power source 35 includes an input 1165 for receiving initial values of power source parameters (i.e., including a voltage value and a current value) that are obtained while preventing the power source 35 from causing kinetic energy to be produced in the electrical load 1158. A control module 1159 (e.g., a controller that sends command signals) is adapted to prevent the power source 35 from causing kinetic energy to be produced in the electrical load 1158. A measurement module 1160 measures initial values of power source parameters, such as, a voltage and a current of the power source 35. The measurement module 1160 measures power flowing out of the power source 35 to obtain the initial values of power source parameters. An estimation module 1161 estimates power capability of a power source 35 based on the initial values of the power source parameters.

In some embodiments, the electric load 1158 is a motor (e.g., electric motor) for a transporter (e.g., transporter 10 as described above in FIG. 1), and the power source 35 drives the motor for a transporter. After initialization of the power source 35, kinetic energy is produced by the motor to create propulsion for the transporter. In some embodiments, control module 1159 commands a mechanical brake (e.g., in the motor of the electrical load 1158) to prevent mechanical motion from being produced by a motor driven by the power source. The motor can be decoupled from the power source 35 to prevent kinetic energy from being produced in the electrical load 1158.

In some embodiments, the electrical load 1158 includes two motors (i.e., a first and second motor) coupled to a common shaft (e.g., a shaft mechanically coupled to the wheels 20 and 21 of a transporter 10 of FIG. 1). The method of estimating power capability of the power source 35 can include commanding the two motors (e.g., commanded by a control module 1159) to produce equal but opposite torque to prevent the power source 35 from causing kinetic energy to be produced in the electrical load 1158. The method can also include commanding the first motor to produce a torque and commanding the second motor with a position control loop (i.e., via control module 1159) to prevent rotation of the shaft, thereby preventing kinetic energy from being produced in the electrical load 1158.

In some embodiments, a method of estimating power capability of the power source 35 includes commanding a component of current supplied to a first motor coupled to a shaft (i.e., by the control module 1159) to be non-zero where the component of the current supplied to the first motor is out of phase with a permanent magnet of the first motor. The method can also include commanding a second motor coupled to the shaft with a position control loop (i.e., via control module 1159) to prevent rotation of the shaft.

In some embodiments, the electrical load can include at least one brushless motor. In some embodiments, the brushless motor is used in a transporter to operate the wheels of the transporter (i.e., wheels 20 and 21 of transporter 10 of FIG. 1). The method of estimating power capability of a power source 35 can include commanding a first component of current supplied to the motor to be substantially equal to zero and a second component of the current supplied to the motor to be non-zero, where the first component is out of phase with a magnetic field of a permanent magnet of the brushless motor and a second component is in phase with the magnetic field of the permanent magnet of the brushless motor. In some embodiments, control module 1159 is adapted to command the current supplied to motor.

As noted above, estimating power capability of a power source 35 (e.g., via estimation module 1161) driving an electrical load 1158 or driving a transporter (e.g., transporter 10 as described above in FIG. 1) can include obtaining initial values of power source parameters, such as including a voltage value and a current value (e.g., via the measurement module 1160), while preventing the power source 35 from causing kinetic energy to be produced in the electrical load 1158. The method can include estimating power capability of the power source 35 based on the initial values of the power source 35 parameters prior to operation of the transporter by a user. The method can also include obtaining a value of a regeneration current (i.e., the current generated in a motor of a transporter by applying a torque in the direction opposite of the direction of travel of the transporter) received by the power source 35 and estimating a voltage from the power source 35 based on the initial values of the power source parameters and the value of the regeneration current received by the power source 35. The method can also include monitoring the voltage from the power source 35 (e.g., where the control module 1159 monitors voltage measured by the measurement module 1160) and shunting a current in the power source 35 once the voltage has reached a threshold value.

In some embodiments, the energy storage capability of the power source 35 is estimated (i.e., by an estimation module 1161) based on the power output capability of the power source. Energy storage capability can be estimated based on a model derived from the same parameters used in estimating power output capability in a battery pack (i.e., namely open circuit voltage (i.e., V_{oc}) and battery impedance (i.e., R_{bat})). Open circuit voltage alone can be used to determine energy storage capability. Energy storage capability can also be determined based on the number of coulombs entering and leaving the battery (i.e., by coulomb counting). Energy storage capability can also be determined based on the battery impedance (e.g., instantaneous battery impedance or measurement of battery impedance over a full discharge of the battery).

The estimate of the power capability of a power source can be used as input to calculating the speed limit for a balancing transporter (e.g., transporter 10 as described above in FIG. 1). One method for determining the speed limit of the vehicle is to monitor the power source voltage, which is then used to estimate the maximum velocity the vehicle is capable of maintaining. Another method is to measure the voltages of the power source and the motor and to monitor the difference between the two. The difference between the voltage of the power system and the motor provides an estimate of the amount of velocity margin (or headroom) currently available to the vehicle. The power source state estimator could be used with many systems that use a power source 35 (e.g., battery) and which has some variation in the load on the power source 35.

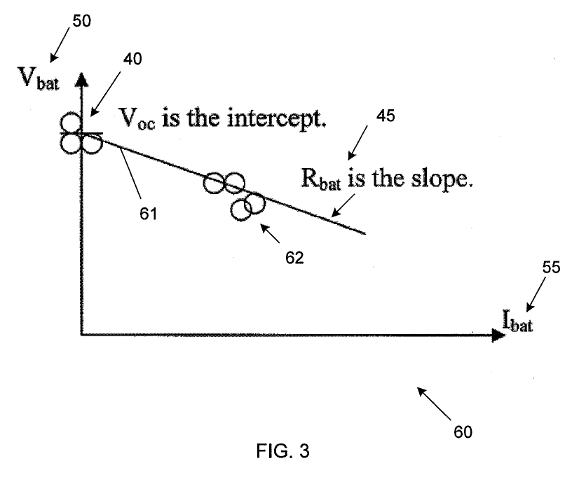

FIG. 3 is a graphical representation of a plot 60 of the model used to estimate an internal impedance of the power source 35 as described in FIG. 2A, according to an illustrative embodiment of the invention. The variables for the power source 35 (e.g., V_{bat} 50, V_{oc} 40, I_{bat} 55, and R_{bat} 45) are defined by the following linear relationship:

V_{bat}=V_{oc}−(I_{bat}*R_{bat}) (EQN. 1)

Measured values of V_{bat} 50 and I_{bat} 55 (represented by circles in plot 60) generally are located along the line 61 defined by EQN. 1. To estimate power capability of a power source, initial values are selected for V_{oc} 40 and R_{bat} 45. When there is no load on the power source, V_{bat} 50 is a good estimate of V_{oc} 40 because there is no current flowing through the power source. A small data set 62 of V_{bat} 50 and I_{bat} 55 is taken while preventing the power source from causing kinetic energy to be produced in the electrical load. A good estimate of R_{bat} 45 is not available until the model includes measurements 62 taken when power is flowing out of the power source. A least squares “best fit” of the model to the data can be performed to estimate R_{bat} 45. The initial estimate for V_{oc} 40 and R_{bat} 45 is used as the initial values for the estimating power capability of the power source. This eliminates the need to otherwise use a conservative R_{bat} 45 estimate at initialization and provides more accurate information for use in decision making and machine control.

Note that “statistical” as used herein, in either adjectival or adverbial form, refers to the drawing of inferences as to the value of a parameter based on sampling the value by measurement at intervals that may be regular or irregular with respect to distribution of the samples in time or in terms of another dimension. The verb “filter” as used herein, and in any appended claims, refers to the process of extracting a value attributable to a single point in time from a plurality of data that may be obtained in successive samplings and may be subject to either random or systematic fluctuations, or both. Application of filtering techniques, as are known in the art, to the data allows estimated values of V_{oc} and R_{bat} to be derived.

A regression analysis using a least squares technique may be employed to derive estimated values of V_{oc} 40 and R_{bat} 45 from the measured values Of V_{bat} 50 and I_{bat} 55. However, V_{oc} 40 and R_{bat} 45 can change due to ambient temperature, power source temperature, power source age, power source usage (i.e., overall amount of usage and usage pattern), and time as the power source charge is depleted and regenerated. Accordingly, a more accurate estimate may be obtained if more recent measured values of V_{bat} 50 and I_{bat} 55 are used for the regression or if more recent values are weighted more heavily than older values. In some embodiments, a recursive least squares technique with exponential forgetting is employed to estimate V_{oc} 40 and R_{bat} 45 for the power source. In another embodiment, measured values of V_{bat} 50 and I_{bat} 55 are used to correct the estimated values using a low pass filtering algorithm.

If measurements 62 cannot be acquired while power is flowing out of the power source, a conservative estimate of R_{bat} 45 can be used at initialization to estimate power capability of the power source. In this embodiment, power is pulled from the power source and kinetic energy is produced (e.g., during operation of a transporter). R_{bat} 45 then slowly gets to the correct value as the machine operates and pulls power out of the power source.

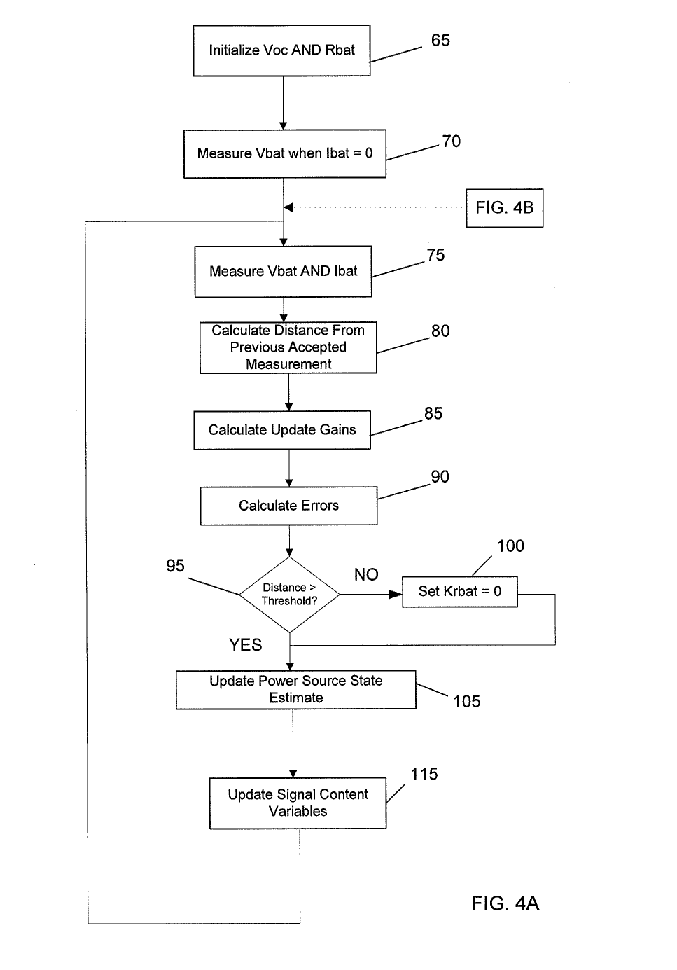

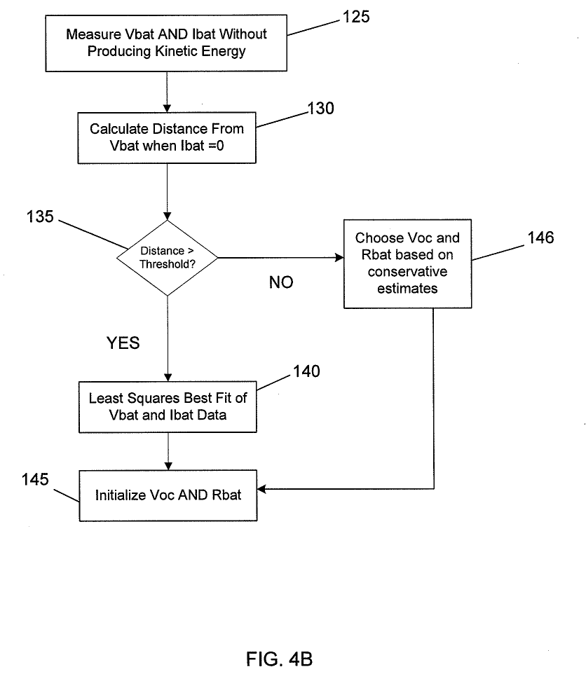

FIG. 4A is a flow diagram illustrating a method for estimating parameters for a power source, according to an illustrative embodiment of the invention. The method may be implemented using a controller (e.g., a controller used to control operation of the transporter 10 of FIG. 1). First the variables are initialized for V_{oc} and R_{bat} (step 65). In some embodiments, initial values for V_{oc} and R_{bat} can be set to typical values. Conservative estimates for V_{oc} and R_{bat} can be used (i.e., R_{bat} is assumed to be as high as possible and V_{oc} is assumed to be as low as possible while still allowing a transporter to function). By way of example, V_{oc} can be set to the actual value of V_{bat} (e.g., the power source voltage) when there is no current (step 70). In some embodiments, V_{oc} is set to a range of about 72 Volts to about 84 Volts. In some embodiments, R_{bat} is set to about 0.9 Ohms to about 1.2 Ohms. Assuming no other minimum battery voltage constraints, the maximum power output capability can be expressed with the following equation:

PowerCapabilityₘₐₓ=V_{oc}²/(2*R_{bat}) (EQN. 2)

In some embodiments, V_{oc} and R_{bat} are initialized by gathering data prior to operation (e.g., prior to operation of the transporter of FIG. 1). One method for acquiring estimates of V_{oc} and R_{bat} before full machine operation involves gathering measurements of V_{bat} and I_{bat} while pulling power out of the power source but while not generating kinetic energy in the electrical load. By pulling power from the power source without generating kinetic energy, it is possible to estimate V_{oc} and R_{bat} before full machine operation. A least squares “best fit” of the model to the measured data (V_{bat} and I_{bat}) can be performed to estimate an initial value for V_{oc} and R_{bat} which can then be used as the initial values for the real time power source state estimator. Estimating an initial value for R_{bat} removes the necessity of using a very conservative R_{bat} estimate at initialization and provides more accurate information of the power capability of the power source, which can be used in decision making and machine control. This method of estimating initial values for R_{bat} and V_{oc} is further described below in FIG. 4B.

After initializing V_{oc} and R_{bat} (step 65) (e.g., either by setting a conservative estimate of R_{bat} or by estimating initial values for R_{bat} based on measurements gathered by pulling power out of the power source while not generating kinetic energy), V_{bat} and I_{bat} are measured periodically 75. To ensure that the signal is sufficiently “rich” (i.e., there is a statistically significant difference between data points) the squared distance, D, of V_{bat} and I_{bat} from the last accepted values of these variables, Vₚᵣₑᵥ and Iₚᵣₑᵥ, is calculated (step 80):

D=(Vₚᵣₑᵥ−V_{bat})+(Iₚᵣₑᵥ−I_{bat})² (EQN. 3)

EQN. 3 identifies data points that may provide additional information from which to refine the estimate of current power source parameters. For example, when there is very little or no electrical load (e.g., the transporter is at rest) little current is drawn. Measurements (e.g., measurements of voltage and/or current of the power source) could skew the estimated value for the power source parameters from their true values as filtering progresses because there may not be statistically significant differences between the data points. To estimate a slope and intercept of a line requires at least two distinct points to define the line, because the slope is equal to the change in the y-value of the two of the two points divided by the change in the x-value of the two points and the intercept is the value of x at the point where the line crosses the y-axis. Data with substantially similar values may not be distinct enough to determine slope and offset. An appropriately set threshold for D can be used to mitigate the impact of such data points on the estimate.

The following calculations may then be performed:
(1) calculate update gains K_{voc} and K_{rbat} (step 85):

$$[ \begin{matrix}{K}_{voc} \\ {K}_{rbat}\end{matrix} ] = [ \begin{matrix}{P}_{a} & {P}_{b} \\ {P}_{b} & {P}_{c}\end{matrix} ] [ \begin{matrix}1 \\ - {I}_{bat}\end{matrix} ] = [ \begin{matrix}{P}_{a} - {P}_{b} * {I}_{bat} \\ {P}_{b} - {P}_{c} * {I}_{bat}\end{matrix} ] \qquad ( EQN . 4 )$$

where Pₐ is the direct V_{oc} covariance matrix element, P_{b} is the cross coupling covariance matrix element, and P_{c} is the direct R_{bat} covariance matrix element. Pₐ, P_{b}, and P_{c} represent the uncertainty in the state estimate.
Next, the method includes, (2) calculating the error between the power source state estimate V_{bat} and the new data point (new measurement for V_{bat} from step 75) (step 90):

Err=V_{bat}−(V_{oc}−I_{bat}*R_{bat}) (EQN. 5)

If D is greater than the threshold (step 95), the method includes (3) updating the power source state estimate (step 105). If D is less than the threshold (step 95), K_{bat} may be set to zero (step 100) so that R_{bat} is not updated.

V_{oc}=V_{oc}+K_{voc}*Err (EQN. 6)

R_{bat}=R_{bat}+K_{rbat}*Err (EQN. 7)

Next, the method includes, (4) updating the signal content variables (step 115), if D is greater than the threshold (step 110):

Vₚᵣₑᵥ=V_{bat} (EQN. 8)

Iₚᵣₑᵥ=I_{bat} (EQN. 9)

The process can continue with repeated measurement of V_{bat} and I_{bat} (step 75).

In some embodiments, V_{oc} is initialized (step 65) to the first measured value of V_{bat}. R_{bat} is set (step 65) to a conservative value (e.g., value higher than expected in typical operation). This approach to initializing R_{bat} allows the algorithm to bring the R_{bat} estimate down during operation. In this embodiment, matrix element P_{b} in EQN. 4 may be set to zero. As described further in FIG. 4B, however, it is also possible to initialize V_{oc} and R_{bat} (step 65) by gathering a small data set by pulling power out the power source without generating kinetic energy and performing a least squares “best fit” of the model to the data, which is further described in FIG. 4B.

In another embodiment of the invention, estimated values of power source parameters are used to calculate a maximum operating speed for a transporter. A maximum operating speed for a transporter (e.g., maximum speed capability of the propulsion system) can be based on V_{oc}, R_{bat}, Iₘₒₜ (i.e., the average current through the motor for the transporter), Kₑ (e.g., a back EMF gain constant) and/or Rₘₒₜ (e.g., motor winding resistance). Iₘₒₜ depends on the torque the motor creates due to, for example, slope of the terrain and payload. In one embodiment, the maximum operating speed of the transporter (Y) is modeled by the following equation:

Y=−\sqrt{3}*(R_{bat}+Rₘₒₜ/2)/Kₑ*Iₘₒₜ+V_{oc}/Kₑ (EQN. 10)

EQN. 10 expresses how fast the motor can spin given the motor current, Iₘₒₜ. However, in some embodiments, the permitted operating speed of the transporter is set less than the actual maximum operating speed of the transporter (Y) in EQN. 10. Buffers (e.g., current buffer, speed buffer) can be used to provide margin to handle transient events. By way of example, EQN. 10 can be modified to include a current buffer (“CurrentBuffer”):

Y=−\sqrt{3}*(R_{bat}+Rₘₒₜ/2)/Kₑ*(Iₘₒₜ+CurrentBuffer)+V_{oc}/Kₑ (EQN. 11)

The “CurrentBuffer” can be variable (e.g., vary with respect to time or an operating condition) or constant. Some amount of margin of speed (i.e., “headroom”) is also used so that the operating speed does not exceed a permitted operating speed of the transporter. By way of example, EQN. 10 can also be modified as follows to include a margin of speed:

Y=−\sqrt{3}*(R_{bat}+Rₘₒₜ/2)/Kₑ*Iₘₒₜ+V_{oc}/Kₑ−SpeedBuffer (EQN. 12)

where “SpeedBuffer” is the margin of speed to desired for operation of the transporter. “SpeedBuffer” can also be variable (i.e., vary with respect to time or an operating condition) or constant. EQNS 10-12, however, can be simplified into the following equation:

Y=M*Iₘₒₜ+B (EQN. 13)

The values for M and B may vary over time and can be functions of operating parameters of the transporter (e.g., power source open circuit voltage and internal resistance) and motor parameters (e.g., backEMF gain and motor resistance). In some embodiments, an estimated maximum operating speed for a transporter is calculated as a linear function of the open circuit voltage of the power source, the internal resistance of the power source and a filtered average motor current, where the value of the average motor current is filtered with a low pass filter.

FIG. 4B is a flow diagram illustrating a method for determining initial values (e.g., step 65 in FIG. 4A) used to estimate parameters for a power source, according to an illustrative embodiment of the invention. Values for V_{oc} and R_{bat} can be initialized (e.g., step 65 in FIG. 4A) based on data gathered from a power source. First, V_{bat} is measured when there is no load on the power source (i.e., I_{bat}=0) (e.g., step 70 in FIG. 4A). V_{bat} is a good estimate of V_{oc} because there is no current flowing through the power source. Power is then pulled from the power source without generating kinetic energy and the current (I_{bat}) and voltage (V_{bat}) is measured (step 125).

A good estimate of R_{bat} cannot be well understood until the algorithm has operated on measurements of I_{bat} and V_{bat} with sufficient richness (i.e., sufficient power should be pulled from the power source). A signal is “rich” if there is a statistically significant difference between data points. In some embodiments, measurements of I_{bat} and V_{bat} with sufficient richness are obtained by pulling a predetermined amount of power through a motor out of a power source (e.g., battery coupled to the motor) over a specified time interval. For example, to obtain measurements with sufficient richness for a 72V battery, approximately 2-3 Amps should be drawn where the nominal operating current range is approximately 25-30 Amps. For a 72 V battery, R_{bat} will typically fall within the range of approximately 0.5 Ohms to about 1.2 Ohms.

In some embodiments, to determine if a signal of sufficient richness has been drawn from the power source, a similar process is used as described above in step 95 of FIG. 4A. As described above, EQN. 3 can be used to calculate the squared distance, D (step 130), between variables V_{bat}_{_{—}}_{zero} and I_{bat}_{_{—}}_{zero} (e.g., step 70 in FIG. 4A) and the values of V_{bat} and I_{bat} (step 125) obtained by pulling power from a power source without producing kinetic energy (e.g., prior to operation of a transporter 10), where V_{bat}_{_{—}}_{zero} and I_{bat}_{_{—}}_{zero} are the values of V_{bat} and I_{bat} when I_{bat}=0. The method includes determining if the squared distance D (i.e., determined at step 130), of V_{bat} and I_{bat} when I_{bat}=0 and V_{bat} and I_{bat} measured without producing kinetic energy exceeds a threshold value (step 135) to ensure that a signal is sufficiently rich.

D=(V_{bat}−V_{bat}_{_{—}}_{zero})²+(I_{bat}−I_{bat}_{_{—}}_{zero})² (EQN. 14)

If D exceeds a threshold, then a least squares “best fit” of the model (step 140) to V_{bat}_{_{—}}_{zero}, I_{bat}_{_{—}}_{zero}, and data from step 125 (i.e., V_{bat} and I_{bat} measured without producing kinetic energy) are used to calculate V_{oc} and R_{bat} to use as initialized values for V_{oc} and R_{bat} (step 145). Those initial values for V_{oc} and R_{bat} are then used to estimate parameters of the power source during operation, as described above in FIG. 4A (i.e., values for step 65 from FIG. 4A). If D does not exceed a threshold, then conservative estimates of V_{oc} and R_{bat} are used (step 146) (i.e., as described above in FIG. 4A where R_{bat} is assumed to be as high as possible and V_{oc} is assumed to be as low as possible while still allowing a transporter to function).

In a power source powered machine with electrical motors, energy is primarily delivered from the power source to produce kinetic energy in the motor. This can happen when the motors are, for example, simultaneously producing torque and rotating. Different methods can be used to measure values for I_{bat} and V_{bat} by pulling power from a power source without producing kinetic energy. For example, in some embodiments, the electrical load includes two motors coupled to a common shaft. The two motors can be commanded to produce equal but opposite torque to prevent the power source from causing kinetic energy to be produced in the electrical load.

In other embodiments, the electrical load includes at least one brushless motor. A first component of current supplied to the motor can be commanded to be substantially equal to zero and a second component of the current supplied to the motor can be commanded to be non-zero. The first component can be out of phase with a magnetic field of a permanent magnet of the brushless motor and produce a mechanical torque. A second component can be in phase with the magnetic field of the permanent magnet of the brushless motor and would not produce a mechanical torque.

In some embodiments, the electrical load includes a first and second motor coupled to a common shaft. The first motor can be commanded to produce a torque and the second motor can be commanded with a position control loop (e.g., with a control module 1159 as described in FIG. 2B) to prevent rotation of the shaft.

In some embodiments, a component of current supplied to a first motor coupled to a shaft is commanded to be non-zero where the component of the current supplied to the first motor is out of phase with a permanent magnet of the first motor. A second motor coupled to the shaft can be commanded with a position control loop to prevent rotation of the shaft.

In some embodiments, a mechanical brake (e.g., in the motor or a transmission of the transporter) is commanded to prevent mechanical motion of the transporter from being produced even if a torque is applied by the motor. In some embodiments, a motor of a transporter is decoupled from a driveline of the transporter and, if a non-zero torque is produced on the motor shaft, rotation of the motor does not produce kinetic motion of the transporter.

The electrical load can vary as a function of time. In some embodiments, where the electrical load includes two motors that produce equal but opposite torque, the two motors are commanded to be synchronized to vary as a function of time. In other embodiments where the electrical load includes at least one brushless motor, the first and second components of the current supplied to the motor are commanded to be synchronized to vary as a function of time. In some embodiments, where the electrical load includes a first and second motor coupled to a common shaft, the first and second motor (e.g, currents supplied to the first and the second motors) can be commanded (e.g., via a control module 1159 as described in FIG. 2B) to be synchronized to vary as a function of time.

Pulling energy out of a power source is important in characterizing its power delivery capabilities. Characterizing the power source without producing kinetic energy is advantageous because it allows greater understanding of the full propulsion system prior to high power operation of the machine. In some embodiments, explicit hardware shunts power source power through a separate resistive path. However, minimizing additional hardware reduces cost and complexity of the machine.

The power dissipated in the motors when the motors are not rotating is proportional to the square of the motor current times the motor resistance. This dissipation power is lesser than the power generated when the motors are rotating. However, as the motor current grows, the power is sufficient to get an accurate estimate of the power source power delivery capability at higher power levels.

Characterizing the power source without producing kinetic energy can be advantageous to estimate the power storage capability of a power source driving an electrical load, such as a transporter. This can be advantageous for a transporter, as described above in FIG. 1, which can produce a regeneration current that can affect the power storage capability of the power source. It is desirable to monitor the current level and voltage level of a power source as the power source and system could fail if the current or voltage level were to exceed a certain value.

For example, actuator systems have a physical limit on the amount of torque they can supply and the amount of electric current that can be in the system. The amount of output torque and current in the actuator system are interrelated, the torque is a function of the current (and vice versa):

T=K_{c}*i (EQN. 15)

where “i” is the current in the actuator system. Constant K_{c} can be based on current limits of the motor drive and motor which can be constraints of how much power can be pulled from the battery. The current limits can be based on temperature limits of the components in the drive and motor. Adjusting the amount of torque adjusts the overall current in the actuator system. Similarly, a current limit limits the amount of torque that can be output by the actuator system. If an actuator has a maximum torque, the current capability also has a maximum. The physical limit on the total amount of electric current in the actuator system applies to all forms of current (e.g., ambient temperature, power source age, current generated by acceleration or deceleration). Any current passing through the vehicle drive utilizes some given portion of the total drive capability and contributes to the overall current limit. For example, regeneration current (i.e. the current generated by applying a torque in the direction opposite of the direction of travel) reduces the amount of current available for braking. Both the regeneration current and the braking current are negative and add towards the overall current limit. An actuator system can monitor how much current (i.e., amount of torque that can be applied in response to the available current) capability is being used for acceleration or deceleration and the actuator system can estimate the remaining current handling ability. By estimating the remaining current handling ability, the system can limit vehicle performance or provide additional braking force through some other means.

A dynamically stabilized transporter may operate so as to maintain a margin for its drive actuator to handle various motoring transients (e.g., needing to accelerate the wheels over small obstacles). For some operating conditions, the wheels need to accelerate to stay underneath the center of mass so as to maintain balance of the vehicle. Similarly, there may be an operational constraint that requires some actuator margin be maintained so as to bring the vehicle to a stop if the system integrity fails. For example, while traveling uphill or on a flat surface, the transporter can stop by accelerating the wheels out in front of the center of mass causing the system to pitch backwards. The backward pitch causes a reduction in torque subsequently reducing speed.

The transporter performance is limited and its speed can be reduced by modulating the pitch of the transporter. This performance reduction can be related to the overall current. The greater the weight of the vehicle and payload and the steeper the slope, the more current can be generated. For example, additional current can be created when traveling uphill, due to the greater torque needed to pitch the vehicle back before stopping. Alternatively, additional current can be created when traveling downhill, due to the regeneration current created when braking. Additional current contributes to the overall current which can cause the overall current limit (i.e., the physical current limit) to be reached, resulting in lowering the speed limit. A lower speed limit lowers the amount of possible sustained deceleration. Reducing the speed limit does not increase the braking capability. However, reducing speed puts the system into an operational state where it is less likely to need to use the braking capability and where the braking capability is used for a shorter time than the time at greater initial speeds. Since the transporter uses the electric motor to generate braking forces, slowing down also regenerates current. The above-described techniques can be implemented in digital electronic circuitry, or in computer hardware, firmware, software, or in combinations of them. The implementation can be as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the invention by operating on input data and generating output. Method steps can also be performed by, and apparatus can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Data transmission and instructions can also occur over a communications network. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

The terms “module” and “function,” as used herein, mean, but are not limited to, a software or hardware component which performs certain tasks. A module may advantageously be configured to reside on addressable storage medium and configured to execute on one or more processors. A module may be fully or partially implemented with a general purpose integrated circuit (IC), FPGA or ASIC. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. Additionally, the components and modules may advantageously be implemented on many different platforms, including computers, computer servers, data communications infrastructure equipment such as application-enabled switches or routers, or telecommunications infrastructure equipment, such as public or private telephone switches or private branch exchanges (PBX). In any of these cases, implementation may be achieved either by writing applications that are native to the chosen platform, or by interfacing the platform to one or more external application engines.

To provide for interaction with a user, the above described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While the invention has been particularly shown and described with reference to specific illustrative embodiments, it should be understood that various changes in form and detail may be made without departing from the spirit and scope of the invention.

1. A method for estimating power capability of a power source driving an electrical load, comprising:
obtaining initial values of power source parameters including a voltage value and a current value while preventing the power source from causing kinetic energy to be produced in the electrical load; and
estimating power capability of the power source based on the initial values of the power source parameters.

2. The method of claim 1, wherein the electrical load comprises two motors coupled to a common shaft and comprising commanding the two motors to produce equal but opposite torque to prevent the power source from causing kinetic energy to be produced in the electrical load.

3. The method of claim 1, wherein the electrical load comprises at least one brushless motor and further comprising commanding a first component of current supplied to the motor to be substantially equal to zero and a second component of the current supplied to the motor to be non-zero, wherein the first component is out of phase with a magnetic field of a permanent magnet of the brushless motor and a second component is in phase with the magnetic field of the permanent magnet of the brushless motor.

4. The method of claim 1, wherein the electrical load comprises a first and second motor coupled to a common shaft and comprising commanding the first motor to produce a torque and commanding the second motor with a position control loop to prevent rotation of the shaft.

5. The method of claim 1, comprising commanding a component of current supplied to a first motor coupled to a shaft to be non-zero wherein the component of the current supplied to the first motor is out of phase with a permanent magnet of the first motor and commanding a second motor coupled to the shaft with a position control loop to prevent rotation of the shaft.

6. The method of claim 1, wherein the electrical load varies as a function of time.

7. The method of claim 1, further comprising commanding a mechanical brake to prevent mechanical motion from being produced by a motor driven by the power source.

8. The method of claim 1, wherein the power source drives a motor and the method comprises decoupling the motor from the power source to prevent kinetic energy from being produced in the electrical load.

9. An apparatus for estimating power capability of a power source driving an electrical load, comprising:
a control module that prevents the power source from causing kinetic energy to be produced in the electrical load;
a measurement module for measuring initial values of power source parameters including a voltage value and a current value; and
an estimation module adapted to estimate power source power capability based on the initial values of the power source parameters.

10. The apparatus according to claim 9, wherein the control module is adapted to command two motors of the electrical load to produce equal but opposite torque to prevent the power source from causing kinetic energy to be produced in the electrical load.

11. The apparatus according to claim 9, wherein the control module is adapted to command a first component of current supplied to a motor of the electrical load to be substantially equal to zero and a second component of the current supplied to the motor to be non-zero, wherein the first component of the current is out of phase with a magnetic field of a permanent magnet of the motor and the second component of the current is in phase with the magnetic field of the permanent magnet of the motor.

12. The apparatus according to claim 9, wherein the control module is capable of commanding a first motor of the electrical load to produce a torque and commanding a second motor of the electrical load, coupled to the first motor with a shaft, with a position control loop to prevent rotation of the shaft.

13. The apparatus according to claim 9, wherein the control module is capable of commanding a component of current supplied to a first motor coupled to a shaft to be non-zero wherein the component of the current is out of phase with a permanent magnet of the first motor and commanding a second motor coupled to the shaft with a position control loop to prevent rotation of the shaft.

14. The apparatus according to claim 9, wherein the measurement module measures power flowing out of the power source to obtain the initial values of power source parameters.

15. The apparatus according to claim 9, wherein the power source is a battery.

16. An apparatus for estimating power capability of a power source driving an electrical load, comprising:
an input for receiving initial values of power source parameters including a voltage value and a current value that are obtained while preventing the power source from causing kinetic energy to be produced in the electrical load; and
an estimation module adapted to estimate power source power capability based on the initial values of the power source parameters.

17. An apparatus for estimating power capability of a power source driving an electrical load, comprising:
a control module that prevents the power source from causing kinetic energy to be produced in the electrical load;
measurement means for measuring initial values of power source parameters including a voltage value and a current value; and
an estimation module adapted to estimate power source power capability based on the initial values of the power source parameters.

18. A method for estimating power capability of a power source driving a transporter comprising:
obtaining initial values of power source parameters including a voltage value and a current value while preventing the power source from causing kinetic energy to be produced in the electrical load; and
estimating power capability of the power source based on the initial values of the power source parameters prior to operation of the transporter by a user.

19. A method for estimating power output capability of a power source driving an electrical load comprising:
obtaining initial values of power source parameters including a voltage value and a current value while preventing the power source from causing kinetic energy to be produced in the electrical load;
obtaining a value of a regeneration current received by the power source; and
estimating a voltage from the power source based on the initial values of the power source parameters and the value of the regeneration current received by the power source.

20. The method of claim 19, further comprising monitoring the voltage from the power source and shunting a current in the power source once the voltage has reached a threshold value.

21. The method of claim 19, further comprising estimating energy storage capability based on the power output capability of the power source.
